(19) United States
(12) Patent Application Publication
(10) Pub. No.: US 2007/0002358 A1
(43) Pub. Date: Jan. 4, 2007

(54) Printing system

(75) Inventor: Hiroshi Yamashita, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/476,674

(22) Filed: Jun. 29, 2006

(30) Foreign Application Priority Data
Jun. 30, 2005 (JP) 2005-192563

(51) Int. Cl. G06F 3/12

(52) U.S. Cl. 358/1.13; 358/1.15

(57) ABSTRACT

A printing system includes a printer monitoring unit which performs output control of data to a printer or status control of the printer, a PDL data generation unit which generates PDL data unique to the printer from printing data output from a printing system for Unix-based OSs, a back-end unit which outputs the PDL data from the PDL data generation unit to the printer monitoring unit, a status display UI unit which performs processing including status display of the printer, and an I/F unit which interfaces between the printer monitoring unit and the PDL data generation unit and interfaces between the printer monitoring unit and the status display UI unit. The printing system can realize generation of PDL data reflecting dynamic device information in a printing system for Unix-based OSs.

### FIELD OF THE INVENTION

The present invention relates to a printing system for Unix-based OSs.

### BACKGROUND OF THE INVENTION

In general, Unix-based OSs adopt a printing system called a CUPS (Common Unix Printing System) as a standard printing system. The CUPS will be explained with reference to FIG. 2. When a CUPS 201 receives a printing request from an application 202, it activates a filter/renderer unit 204 suitable for printing data, and also activates a back-end unit 205 in accordance with the connection form of a printer 210. At this time, the filter/renderer unit 204 converts the printing data into PDL data on the basis of startup parameters and outputs the PDL data to the back-end unit 205.

In many cases, the printer 210 is connected on the output side of the back-end unit 205. In the printing system for Unix-based OSs, a printer monitoring unit 206 for controlling the printer 210, acquiring the status, and controlling output data is sometimes interposed between the back-end unit 205 and the printer 210. In this case, the printer monitoring unit 206 operations as a process separate from that of the CUPS 201. The printer monitoring unit 206 often interfaces with a status display UI unit 207 which displays the status of the printer 210.

See the following URL [Common UNIX Printing System] (URL:http://www.cups.org/) for details of the CUPS.

Recent advanced host-based printers must generate PDL data by reflecting dynamic device information such as the presence/absence of a double-sided unit at the start of printing and calibration information.

However, conventional printing systems for Unix-based OSs cannot generate PDL data which reflects dynamic device information.

### SUMMARY OF THE INVENTION

The present invention has been made to overcome the conventional drawbacks, and has as its object to provide a printing system which realizes the generation of PDL data reflecting dynamic device information.

A printing system according to the present invention is characterized by comprising a printer monitoring unit adapted to perform at least output control of data to a printer or status control of the printer, a PDL data generation unit adapted to generate PDL (Page Description Language) data unique to the printer from printing data output from a printing system for a Unix-based OS (Operating System), a back-end unit adapted to output the PDL data from the PDL data generation unit to the printer monitoring unit, a status display UI (User Interface) unit adapted to perform processing including status display of the printer, and an I/F unit adapted to interface between the printer monitoring unit and the PDL data generation unit and interface between the printer monitoring unit and the status display UI unit.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic configuration of a printing system according to an embodiment of the present invention;

FIG. 2 is a block diagram showing the schematic configuration of a CUPS (Common Unix Printing System);

FIG. 3 is a flowchart showing processing of a PDL data generation unit;

FIG. 4 is a flowchart showing details of device information acquisition processing in step 303 shown in FIG. 3;

FIG. 5 is a flowchart showing processing of a status display UI unit;

FIG. 6 is a flowchart showing processing of a printer monitoring unit;

FIG. 7 is a flowchart showing details of I/F unit initialization processing in step 401 of FIG. 4 and step 502 of FIG. 5;

FIG. 8 is a flowchart showing details of I/F unit request & acquisition processing in step 403 of FIG. 4 and step 505 of FIG. 5;

FIG. 9 is a flowchart showing details of I/F unit end processing in step 404 of FIG. 4 and step 508 of FIG. 5; and

FIG. 10 is a block diagram showing the system configuration of the printing system according to the embodiment of the present invention.

### DETAILED DESCRIPTION OF THE PREFERRED EMBODIMENT

A printing system according to an embodiment of the present invention will be described in detail below.

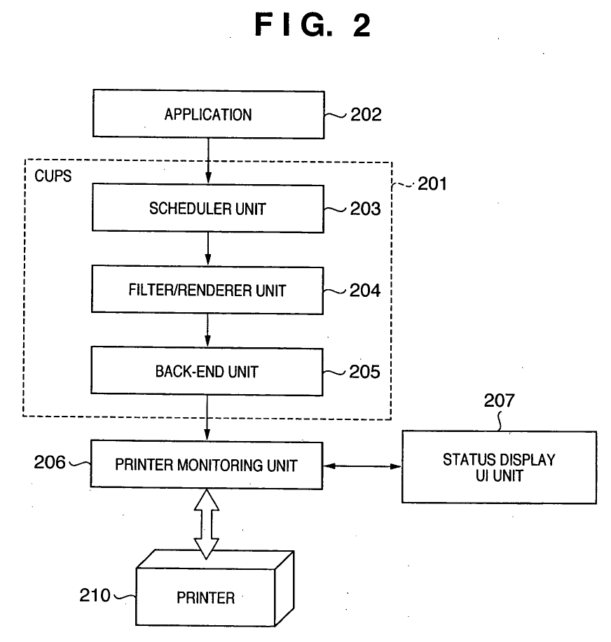

The embodiment of the present invention is related to a printer monitoring unit 206, a status display UI unit 207, and a processing unit which generates PDL data as a function of part of a filter/renderer unit 204 in a CUPS 201 serving as a standard printing system for Unix-based OSs shown in FIG. 2.

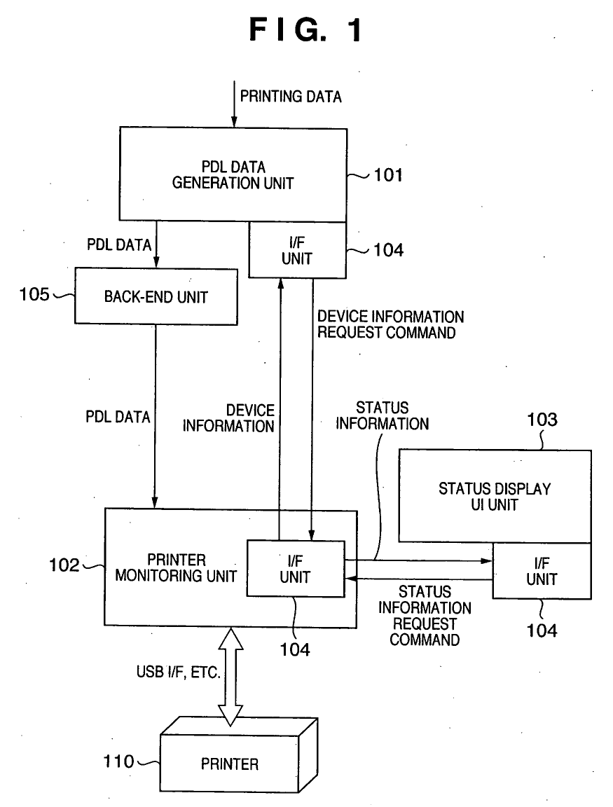

FIG. 1 is a block diagram showing the schematic configuration of the printing system according to the embodiment of the present invention.

The printing system according to the embodiment comprises a PDL data generation unit 101 which generates PDL (Page Description Language) data unique to a printer 110 from printing data output from a printing system for Unix-based OSs (Operating Systems), a printer monitoring unit 102 which performs at least output control of data to the printer 110 or status control of the printer 110, a status display UI (User Interface) unit 103 which performs processing including status display of the printer 110, I/F units 104 which interface between the printer monitoring unit 102 and the PDL data generation unit 101 and interface between the printer monitoring unit 102 and the status display UI unit 103, and a back-end unit 105 which outputs PDL data from the PDL data generation unit 101 to the printer monitoring unit 102. The PDL data generation unit 101, printer monitoring unit 102, and status display UI unit 103 operate as separate processes.

The I/F units 104 perform interprocess communication using a socket between the PDL data generation unit 101 or status display UI unit 103 and the printer monitoring unit 102 serving as another process. The embodiment implements interprocess communication using a socket, but the means for implementing interprocess communication is not limited to the socket.

The printer monitoring unit 102 controls the printer 110, and controls output data. In addition, the printer monitoring unit 102 acquires, from the printer 110, data corresponding to a request command received from the I/F unit of another processing unit (PDL data generation unit 101 or status display UI unit 103), and transmits the data to the I/F unit of the requesting processing unit.

The PDL data generation unit 101 is a function of part of a filter/renderer unit 204 shown in FIG. 2, and generates PDL data from printing data output from the filter or renderer.

The status display UI unit 103 displays the status of the printer 110. The back-end unit 105 outputs PDL data from the PDL data generation unit 101 to the printer monitoring unit 102.

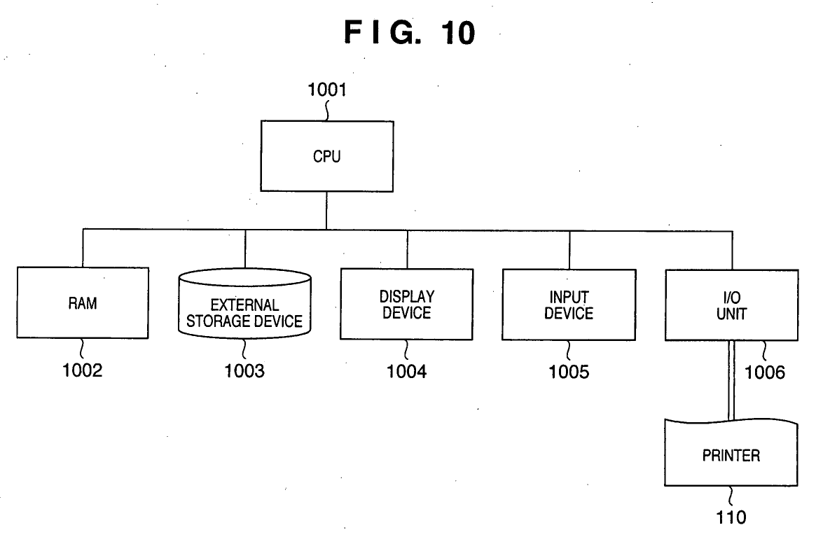

FIG. 10 is a block diagram showing the system configuration of the printing system according to the embodiment of the present invention.

In FIG. 10, a CPU 1001 is a central processing unit which controls the printing system of the embodiment. A RAM 1002 is a storage device for loading and activating a program in the printing system of the embodiment and temporarily storing data. An external storage device 1003 is formed from an HDD or the like, and stores a program in the printing system of the embodiment. A display device 1004 is formed from a CRT, LCD, or the like, and displays the UI window of the status display UI unit 103 in FIG. 1 and the like. An input device 1005 is formed from a keyboard or the like, and used for various inputs and instructions. An I/O unit 1006 is a physical interface (e.g., a USB) for connecting the printer 110.

The flow of processing in the printing system according to the embodiment of the present invention will be described in detail. First, the flow of processing by the PDL data generation unit 101 will be explained.

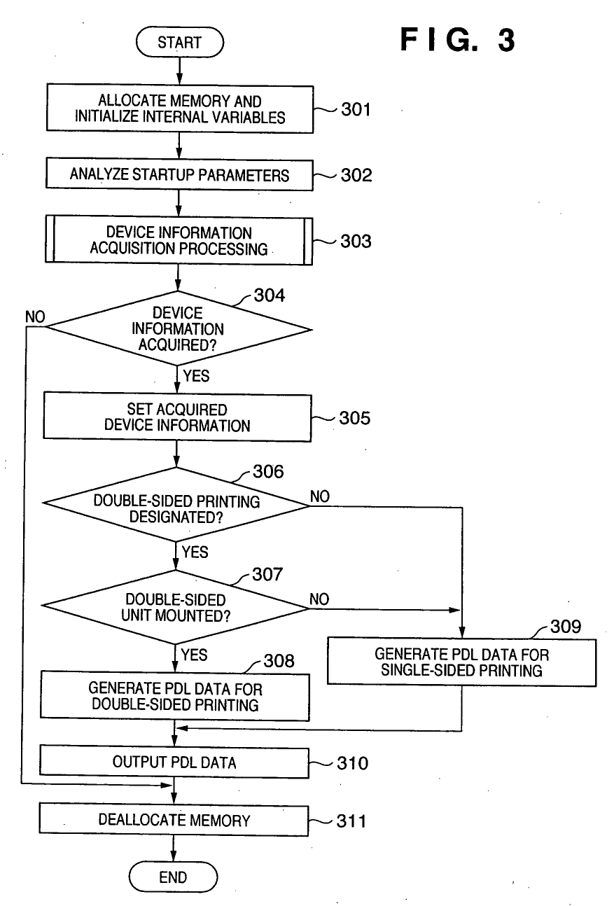

FIG. 3 is a flowchart showing the processing of the PDL data generation unit 101.

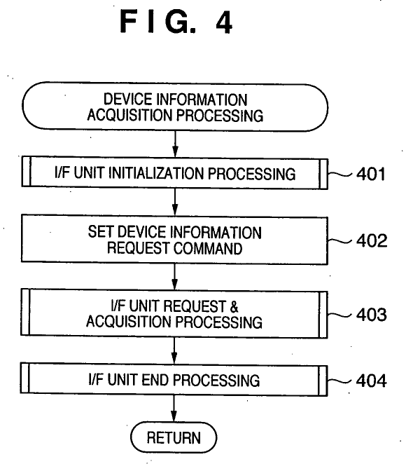

In step 301, the memory is allocated, and internal variables are initialized and set as default values. In step 302, startup parameters are analyzed, and the internal variables are updated to values designated by the startup parameters. In step 303, device information acquisition processing (see FIG. 4 for details thereof) is performed to acquire device information.

In step 304, it is determined whether the device information can be acquired without any error in step 303. If it is determined in step 304 that no device information can be acquired, the flow advances to step 311 to perform end processing such as memory deallocation, and the process ends. If it is determined in step 304 that device information can be acquired, the flow advances to step 305 to update the device information to a corresponding internal variable.

In step 306, it is determined whether double-sided printing is designated by the single/double-sided printing setting of the startup parameter. If it is determined in step 306 that double-sided printing is designated, the flow advances to step 307. If it is determined in step 306 that no double-sided printing is designated, the flow advances to step 309 to generate PDL data for single-sided printing, and then to step 310.

In step 307, whether a double-sided unit is mounted in the device is determined from the device information acquired in step 303. If it is determined in step 307 that a double-sided unit is mounted in the device, the flow advances to step 308 to generate PDL data for double-sided printing without changing the setting. If it is determined in step 307 that no double-sided unit is mounted in the device, the flow advances to step 309 to generate PDL data for single-sided printing, and then to step 310.

In step 310, the generated PDL data is output to the back-end unit 205. In step 311, end processing such as memory deallocation is performed, and the process ends.

Details of the device information acquisition processing in step 303 shown in FIG. 3 will be explained. FIG. 4 is a flowchart showing details of the device information acquisition processing in step 303 shown in FIG. 3.

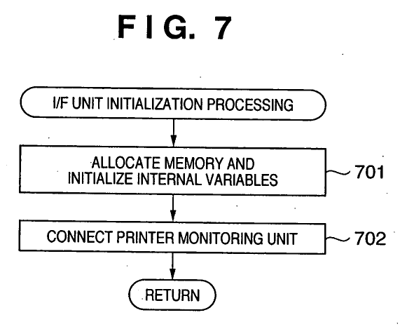

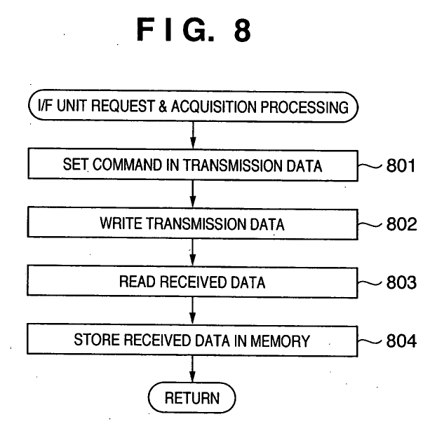

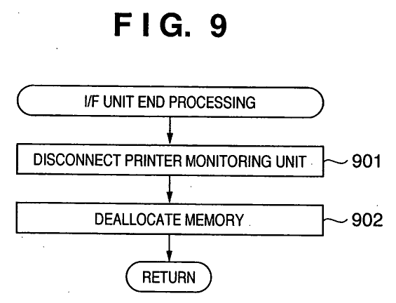

In step 401, initialization processing of the I/F unit 104 (see FIG. 7 for details thereof) is performed. In step 402, a device information request command is set. In step 403, a data acquisition processing request (see FIG. 8 for details thereof) is issued to the I/F unit 104 of the printer monitoring unit 102. After device information is acquired, the device information data is stored in the memory. In step 404, I/F unit end processing (see FIG. 9 for details thereof) is performed, and the processing in FIG. 4 ends.

The flow of processing by the status display UI unit 103 will be explained.

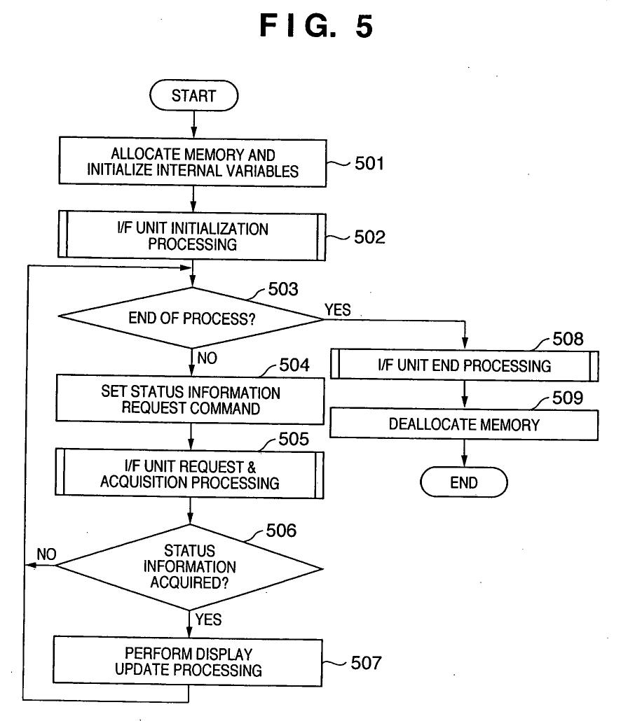

FIG. 5 is a flowchart showing the processing of the status display UI unit 103.

In step 501, the memory is allocated, and internal variables are initialized. In step 502, initialization processing of the I/F unit 104 (see FIG. 7 for details thereof) is performed.

In step 503, a signal associated with the end of the process such as an end button event by the user is executed to determine whether to end the process. If it is determined in step 503 that the process is to end, the flow advances to step 508 to perform end processing of the I/F unit 104 (see FIG. 9 for details thereof). Then, the flow advances to step 509 to deallocate the memory, and the process ends. If it is determined in step 503 that the process is not to end, the flow advances to step 504 to set a status request command. After that, the flow advances to step 505 to issue a data acquisition processing request (see FIG. 8 for details thereof) to the I/F unit 104 of the printer monitoring unit 102.

In step 506, it is determined whether status information can be acquired without any error. If it is determined in step 506 that the status information can be acquired, the flow advances to step 507 to perform UI display update processing, and returns to step 503. If it is determined in step 506 that no status information can be acquired, the flow returns to step 503.

Processes by the I/F unit in FIGS. 4 and 5 will be described in detail.

FIG. 7 is a flowchart showing details of the I/F unit initialization processing in step 401 of FIG. 4 and step 502 of FIG. 5.

When the I/F unit initialization processing starts, the memory is allocated, and internal variables are initialized in step 701. In 702, the I/F unit 104 of the printer monitoring unit 102 is connected and undergoes the I/F unit initialization processing.

FIG. 8 is a flowchart showing details of the I/F unit request & acquisition processing in step 403 of FIG. 4 and step 505 of FIG. 5.

In step 801, a request command is set in transmission data. In step 802, the transmission data is written in a socket connected to the printer monitoring unit 102. After the end of write, the header field of received data is read from the socket in step 803. In step 804, the data field of the received data is read to achieve the I/F unit request & acquisition processing.

FIG. 9 is a flowchart showing details of the I/F unit end processing in step 404 of FIG. 4 and step 508 of FIG. 5.

When the I/F unit end processing starts, the I/F unit 104 of the printer monitoring unit 102 is disconnected in step 901. In step 902, the memory is deallocated to achieve the I/F unit end processing.

The flow of processing by the printer monitoring unit 102 will be explained.

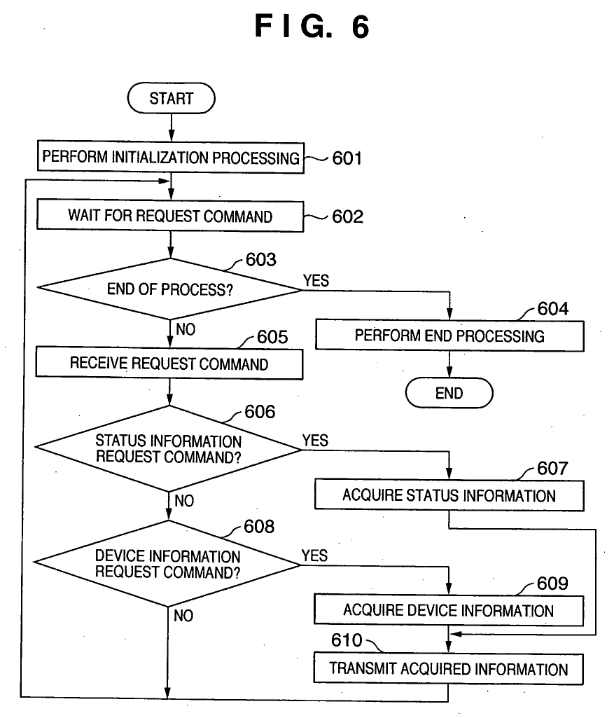

FIG. 6 is a flowchart showing the processing of the printer monitoring unit 102.

In step 601, a data area for use is initialized, and the flow waits for connection of a socket from the I/F unit of another processing unit (PDL data generation unit 101 or status display UI unit 103). If the I/F unit of another processing unit is connected, the flow waits for a request command from the I/F unit of the processing unit in step 602.

In step 603, reception of a signal associated with the end of the process is checked to determine whether to end the process. If it is determined in step 603 that the process is to end, the flow advances to step 604 to perform end processing, and the process ends. If it is determined in step 603 that the process is not to end, the flow advances to step 605 to read received data containing a request command and extract the request command.

In step 606, it is determined whether the request command received in step 605 is-a status information request command. If it is determined in step 606 that the received request command is a status information request command, the flow advances to step 607 to acquire status information from the printer 110. Thereafter, the flow advances to step 610. If it is determined in step 606 that the received request command is not a status information request command, the flow advances to step 608.

In step 608, it is determined whether the request command received in step 605 is a device information request command. If it is determined in step 608 that the received request command is a device information request command, the flow advances to step 609 to acquire device information from the printer 110. Then, the flow advances to step 610.

In step 610, the information acquired from the printer 110 is set in transmission data, and transmitted to the I/F unit of another processing unit (PDL data generation unit 101 or status display UI unit 103) which has requested acquisition.

If the processing in step 610 ends or it is determined in step 608 that the received request command is not a device information request command, the flow returns to step 602 to wait for reception of the next request command.

As has been described above, according to the present invention, a conventional interface unit of the printer monitoring unit with the status display UI (User Interface) unit for displaying the status is extended, and the same interface unit is shared even with the PDL data generation unit. As a result, dynamic device information can be reflected in the PDL data generation unit, and the PDL data generation unit can generate PDL data which reflects dynamic device information. Since the interface unit of the printer monitoring unit can be shared between the status display UI (User Interface) unit and the PDL data generation unit, downsizing of the respective modules and reduction of the design cost can be realized.

As many apparently widely different embodiments of the present invention can be made without departing from the spirit and scope thereof, it is to be understood that the invention is not limited to the specific embodiments thereof except as defined in the claims.

This application claims the benefit of Japanese Application No. 2005-192563, filed Jun. 30, 2005, which is hereby incorporated by reference herein in its entirety.

What is claimed is:

1. A printing system comprising:
a printer monitoring unit adapted to perform at least output control of data to a printer or status control of the printer;
a PDL data generation unit adapted to generate PDL (Page Description Language) data unique to the printer from printing data output from a printing system for a Unix-based OS (Operating System);
a back-end unit adapted to output the PDL data from said PDL data generation unit to said printer monitoring unit;
a status display UI (User Interface) unit adapted to perform processing including status display of the printer; and
an I/F unit adapted to interface between said printer monitoring unit and said PDL data generation unit and interface between said printer monitoring unit and said status display UI unit.

2. The system according to claim 1, wherein
said PDL data generation unit or said status display UI unit transmits, to said printer monitoring unit via said I/F unit, a request command corresponding to information to be acquired, and
said printer monitoring unit analyzes the request command received from said I/F unit, acquires the information corresponding to the request command from the printer, and transmits the acquired information to a requesting destination via said I/F unit.

3. The system according to claim 2, wherein said PDL data generation unit transmits a device information request command associated with the printer to said printer monitoring unit via said I/F unit, and acquires device information associated with the printer from said printer monitoring unit.

4. The system according to claim 3, wherein said PDL data generation unit generates PDL data suitable for a status of the printer at a start of printing on the basis of the device information which is acquired via said I/F unit and associated with the printer, and outputs the PDL data to said back-end unit.

5. The system according to claim 2, wherein said status display UI unit transmits a status information request command associated with the printer to said printer monitoring unit via said I/F unit, acquires status information associated with the printer from said printer monitoring unit, and displays the acquired status information.
